(19) United States
(12) Patent Application Publication
(10) Pub. No.: US 2008/0250912 A1
(43) Pub. Date: Oct. 16, 2008

(54) Drumstick, a percussion element for a drumstick and use of such a drumstick or such a percussion element

(76) Inventors: Albert Jaap Van Dorssen, Delft (NL); Juan Marcel Van Emmerloot, RD Rijen (NL)

Correspondence Address: LADAS & PARRY, 5670 WILSHIRE BOULEVARD, SUITE 2100, LOS ANGELES, CA, 90036-5679, US

(21) Appl. No.: 11/787,264

(22) Filed: Apr. 12, 2007

(51) Int. Cl. G10D 13/00

(52) U.S. Cl. 84/422.4

(57) ABSTRACT

The present invention relates to a drumstick comprising an elongated handle, which is provided at one end thereof with a percussion element for producing the sound of a beat, wherein the percussion element comprises at least two branches that diverge from the handle. The invention further relates to a percussion element for a drumstick and to the use of such a drumstick and/or such a percussion element.

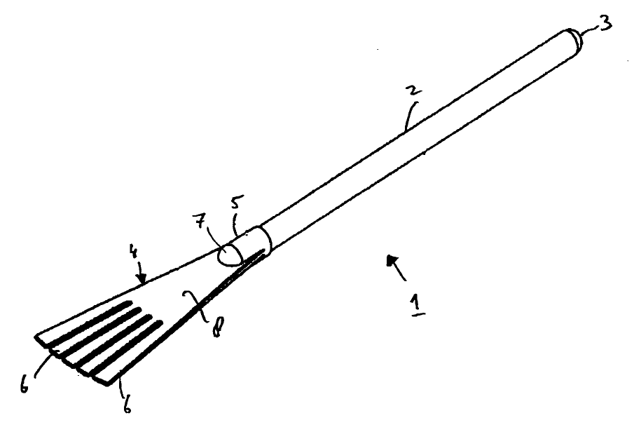

The present invention relates to a drumstick comprising an elongated handle, which is provided at one and thereof with a percussion element for producing the sound of a beat.

Such drumsticks are generally known, they consist of a wooden stick provided with a cone-shaped end having a slightly round tip as the percussion element. The tip may be made of wood in one piece with the handle, but it is also known to provide the percussion element with a plastic tip or cover for forming the tip on the wooden stick. A drawback of the known drumstick is that it is only capable of producing a dry tap as the sound of a beat. To produce a rolling sound, the drum must be struck a number of times in quick succession, frequently using two sticks, by which the drumhead is alternately struck. A rolling sound may also be simulated by fitting the drum that is struck with strings, which can be set vibrating via a skin, usually a skin that is stretched over the bottom side of the drum, by striking the drumhead.

The object of the present invention is to provide a drumstick as mentioned in the introduction, by means of which a sound having a more roll-like character than the dry tap produced with a conventional drumstick can be produced with a single stroke. The term “roll-like” is understood to mean that the sound is less concentrated, giving the impression of a number of taps from a quick succession of strokes. This object is achieved by the present invention in that the percussion element comprises at least two branches that diverge from the handle. This makes it possible to have the branches make contact with the drumhead non-simultaneously upon striking the drumhead, as a result of which at least two beats of he respective branches on the drumhead are generated in quick succession with only one stroke of the drumstick. The branches may have the shape of flat fingers.

For producing an noise-like sound, so-called brushes are known, which brushes are “swept” over a drumhead. Drummers also make striking motions with such brushes, but because of the hairy ends such it is not possible to produce the sound of a beat with such striking motions. Said brushes cannot be qualified as drumsticks, therefore. In addition, the bristles, which are bound together and attached to the handle, cannot be regarded as branches.

U.S. Pat. No. 5,404,784 describes a percussion instrument which is a cross between a drumstick and a brush. The percussion instrument comprises a hollow handle through which a control rod extends between an element for translating the control rod in the longitudinal direction of the handle and a pin for holding together a number of metal fingers, whose tension can be increased or decreased by translating the control rod and which are intended for striking a percussion instrument, such as a drum. The fingers are loose, thin and narrow metal strips stacked together and interconnected by means of a pin, which may be arranged in a fan-like manner so as to provide a brush-like percussion instrument or be stacked upon each other, so that a single dry tap can be produced, as with a conventional drumstick.

Preferably the number of branches is three or more so as to be able to generate a larger number of beats of the percussion instrument with a single stroke of the drumstick.

To realise a good balance while drumming, it is preferable to use an uneven number of branches. The middle branch may be in line with the handle in that case, whilst the other branches may extend at least substantially symmetrically relative to the longitudinal axis of the middle branch.

In a preferred embodiment of the present invention, the branches have an at least substantially flat end. As a result, a line which is interrupted by the free spaces between the ends of the branches is formed, as it were, where the branches make contact with a drum, in addition, because of this aspect the branches each have a comparatively large area of contact, because they can make contact with the drum over the entire width of their ends during a stroke.

Preferably, the thickness of the branches decreases at least substantially gradually in the direction of the ends of the branches. This makes it possible on the one hand to make the ends of the branches slightly resilient, whilst on the other hand the branches are stronger near their beginnings, thereby preventing the branches from buckling when a comparatively large force is exerted thereon, for example during a hard stroke.

In a preferred embodiment of the present invention, the percussion element and the handle are separate, interconnected parts. This makes it possible to manufacture the two parts separately, using specific materials having the desired properties.

It is preferable in that connection if the percussion element comprises a sleeve-like part, via which the percussion element is slid over one end of the handle. The sleeve-like part can be easily connected to the end of a handle, which will often have a round cross-section in the case of a drumstick. If the sleeve is moreover configured to have a comparatively large outer circumference and has a rounded, for example semi-spherical, shape at the end facing towards the branches, the sleeve may moreover be used for striking a drumhead, for example by maintaining the drumstick in a relatively horizontal position. As a result, the outer circumference of the sleeve will hit the drumhead approximately simultaneously with the ends of the branches. A closed end of the sleeve which is rounded on the outside will prevent damage to the drumhead in that case.

According to a preferred embodiment of the present invention, the percussion element is made of a plastic material. Many plastics are easy to process and are capable of combining strength/rigidity with a comparatively low specific weight. Plastics are generally relatively inexpensive, Polypropylene, for example, is a suitable plastic, by means of which a good combination of rigidity and resistance to cracking can be achieved. Polyoxymetylene is another example of a suitable synthetic plastic, from which a comparatively rigid percussion element can be manufactured for even more successfully producing a desired tap sound effect.

It is advantageous if the percussion element is a moulded product. Moulded products can be produced in a comparatively simple, quick and inexpensive manner, using moulds, for example by injection-moulding plastic material. It may be advantageous if the percussion element is configured as an integral element.

In a preferred embodiment of the present invention, the handle is made of wood. Wood has proven to be a material which is suitable for drumsticks, and in addition it lowers the acceptation threshold for the use of such a drumstick by drummers.

In an alternative embodiment of the invention, the handle and the percussion element form an integral unit. The drumstick can be produced at comparatively low cost in that case, for example as an integral, injection-moulded product.

It is advantageous if the handle has a substantially round cross-section along its entire length. This will give a user of a drumstick a familiar, known feeling while drumming.

Alternatively it may be advantageous if the handle has an unround cross-section near the part where the handle is to be held while drumming with the percussion element. In contrast to a conventional drumstick, it is not possible to wield a drumstick according to the present invention in any orientation thereof, because the branches must make contact with the drumhead in the correct manner, in which connection the orientation of the branches is important. An unround handle can help a user to hold the drumstick in the desired orientation by feel.

Preferably, the centre of gravity of the drumstick is located in the middle of the drumstick, seen in the longitudinal direction. This, too, contributes towards giving the user of the drumstick a natural, familiar feel. In connection with said familiar feel it is moreover advantageous if the length of the drumstick is similar to that of a conventional drumstick, i.e. about 40 cm, and thus is at least 35 cm, furthermore preferably to at least 37.5 cm.

In a preferred embodiment of the present invention, the length of the percussion instrument is smaller than the length of the handle. This enables a user to hold the drumstick by the handle, near the middle of the drumstick, if the proportion between the length of the handle and that of the percussion element is about 2:1, the stick can simply be held “back to front”, making it possible to drum with the back end of the handle as well.

It is advantageous in that regard if the end of the drumstick opposite the percussion element is arranged as a conventional percussion end of a drumstick. It may be decided in that case to configure the end of the drumstick opposite the percussion element as a percussion end with a tip of a conventional drumstick.

In a preferred embodiment of the present invention, the branches lie in at least substantially the same plane. This makes it possible to realise an advantageous weight distribution, with a straight contact surface of the drumstick.

According to a second aspect thereof, the present invention relates to a percussion element for use with a drumstick according to the first aspect of the invention. The advantages and variants of such a percussion element correspond to that which has been described in the foregoing.

According to a third aspect thereof, the present invention relates to the use of a drumstick and/or a percussion element according to the first and the second aspect, respectively, of the present invention. The advantages of the use of such a drumstick or such a percussion element have already been discussed in the foregoing.

The present invention will be explained in more detail hereinafter on the basis of an embodiment of a drumstick according to the present invention as shown in the appended figure.

The figure shows a drumstick 1 with an elongated, round wooden handle 2 having a spherical end 3, to the opposite end of which a polypropylene percussion element 4, which has been formed as one unit by injection-moulding, is attached. The percussion element 4 comprises a substantially flat blade 8, which is slid over one end of the handle 2 via a sleeve-shaped part 5 and clamped in position thereon. The sleeve-like part 5 is closed by a spherical part 7 on the side of the branches formed as fingers 6. The percussion element 4 extends from the handle 2 in a direction away therefrom, branching into five fingers 6 approximately halfway the percussion element 4. The blade 8 of the percussion element 4 is relatively thick near the spherical part 7, with the thickness of the blade 8 gradually decreasing in the direction of the ends of the fingers 6. The length of the handle 2 is about twice the length of the blade B of the percussion element 4.

The drumstick 1 can be used for striking a drum both with the fingers 6 and with the spherical end 3 of the handle 2, The weight distribution of the drumstick 1 is substantially the same as the weight distribution of a traditional drumstick, with the centre of gravity being located approximately in the middle of the drumstick, so that the feel upon wielding the drumstick 1 according to the present invention is similar to the feel upon wielding a conventional drumstick. When a drum is struck with the spherical end 3 of the handle 2, the sound that is produced is comparable to the sound of a tap produced when a drum is struck with a conventional drumstick. If a drum is struck with the percussion element 4, however, the fingers will make contact with the drum more or less non-simultaneously, depending on the orientation of the fingers with respect to the drum (not shown), and thus produce the sound of a quick succession of taps.

Only one exemplary embodiment of a drumstick according to the present invention has been described in the foregoing. The description and the figure have no limitative effect as regards the scope of the present invention, which is defined in the appended claims. Several obvious variations are conceivable to those of average skill in the art, which variations all fall within the scope of the present invention. Thus it is possible, for example, to configure part of the handle with an oval cross-section, so that the drummer can hold the drumstick in the correct orientation by feel. Furthermore, the percussion element may be provided with a different number of fingers, either with fewer (2, 3 or 4) fingers or with more (6, 7, 8, 9, . . . ) fingers. The handle and the percussion element may also form an integral element, for example an injection-moulded element.

1. A drumstick comprising an elongated handle, which is provided at one end thereof with a percussion element for producing the sound of a beat, wherein the percussion element comprises at least two branches that diverge from the handle.

2. A drumstick according to claim 1, characterised in that the number of branches is three or more.

3. A drumstick according to claim 1, characterised in that an uneven number of branches is used.

4. A drumstick according to claim 1, characterised in that the branches have an at least substantially flat end.

5. A drumstick according to claim 1, characterised in that the thickness of the branches decreases at least substantially gradually in the direction of the ends of the branches.

6. A drumstick according to claim 1, characterised in that the percussion element and the handle are separate, interconnected parts.

7. A drumstick according to claim 1, characterised in that the percussion element comprises a sleeve-like part, via which the percussion element is slid over one end of the handle.

8. A drumstick according to claim 1, wherein the percussion element is made of a plastic material.

9. A drumstick according to claim 1, wherein the percussion element is a moulded product.

10. A drumstick according to claim 1, wherein the handle is made of wood.

11. A drumstick according to claim 1, wherein the handle and the percussion element form an integral unit.

12. A drumstick according to claim 1, wherein the handle has a substantially round cross-section along its entire length.

13. A drumstick according to claim 1, wherein the handle has an unround cross-section near the part where the handle is to be held while drumming with the percussion element.

14. A drumstick according to claim 1, wherein the centre of gravity of the drumstick is located in the middle of the drumstick, seen in the longitudinal direction.

15. A drumstick according to claim 1, wherein the length of the percussion instrument is smaller than the length of the handle.

16. A drumstick according to claim 1, wherein the end of the drumstick opposite the percussion element is arranged as a conventional percussion end of a drumstick.

17. A drumstick according to claim 1, wherein the branches lie at least substantially in the same plane.

18. A percussion element for use with a drumstick according to claim 1.

19. Use of a drumstick according to claim 1.

20. Use of a percussion element according to claim 18.
